(19) United States
(12) Patent Application Publication
(10) Pub. No.: US 2026/0026423 A1
(43) Pub. Date: Jan. 29, 2026

(54) MASS FLOW HARVEST DETECTION TOOL FOR IMPROVED FARMING OPERATIONS

(71) Applicant: AGI SURETRACK LLC, Lenexa, KS (US)

(72) Inventors: Robert Sterling NESBITT, Old Lyme, CT (US); Daniel J. MOLA, Paola, KS (US)

(21) Appl. No.: 18/747,047

(22) Filed: Jun. 18, 2024

(51) Int. Cl. A01B 79/00; A01B 79/02; A01D 41/127; G06N 3/04

(52) U.S. Cl. CPC A01B 79/005; A01B 79/02; A01D 41/1271; G06N 3/04

(57) ABSTRACT

This disclosure generally relates to removing or reducing a time delay between sensor data using a computational, inexpensive numerical method or a machine learning model to generate more accurate prescription maps used to perform future work operations. In one aspect, a first time-stamped signal and a second time-stamped signal are cross-correlated to apply a time delay to the first time-stamped signal to generate a time-invariant data set. The first time-stamped signal corresponds to sensor data indicative of mass flow rate, and the second time-stamped signal corresponds to sensor data indicative of engine torque. In one aspect, a machine learning model is trained to remove the time delay of the first time-stamped signal based on labeled time delays corresponding to different sensor signals. Reducing effects of these time delays associated with sensor data can improve overall farming operations, enhance crop output, increase operational efficiency of work vehicles, and reduce fuel emissions.

### BACKGROUND

The present disclosure generally relates to a harvester system. More particular, aspects of the present disclosure generally relate to a mass flow harvest detection tool for improved farming operations.

The agricultural industry employs a variety of tools and machines to harvest different kinds of crops. For example, a harvester is a machine that uses a thresher to harvest a first type of crop, such as wheat, barley, and the like, or that uses additional machinery, such as drums, to harvest a second type of crops, such as cotton. Certain sensors are employed on the harvester to provide agricultural metrics, at or near real-time.

### SUMMARY

At a high level and without limitation, aspects described herein relate to a harvester system and methods of use. Particular aspects relate to a harvester and methods for reducing or eliminating a delay in sensor signals to generate improved prescription maps or improved plots with higher positional accuracy. In this manner, embodiments of the present disclosure perform technical operations to improve cropping efficiency, improve crop production, reduce resource waste and fuel consumption associated with workflows based on inefficient or inaccurate prescription maps or plots, and enhance confidence in more accurate technology.

In one example, a harvester refers to a device, such as a work vehicle, that includes an attachment that collects agricultural product as the harvester travels across the field. To facilitate operation, certain harvesters include sensors, such as an engine torque sensor, an engine load sensor, a mass flow sensor, and other sensors. The sensor signals (also referred to herein in some examples as “time-stamped signals”) of these or other sensors are used to generate a prescription map or other plots. In one embodiment, the sensor signals are associated with a corresponding timestamp. In one example, a prescription map refers to a file that includes operating parameters for certain components of a machine operating in certain positions (or geographic coordinates) within a field. In one example, operating parameters refers to the desired parameters for operating certain components of a harvester or other work vehicle to maximize or improve throughput, crop harvesting, and the like, while also reducing emissions, waste, and the like.

For example, in the context of a harvester operating on the field, a computing device associated with the harvester accesses the prescription map to instruct components of the harvester, such as the engine of the harvester and actuators of the harvester (for example, controlling a header, reel, cutter bar, sieves, rotating blades, unloading pipe, augers, conveyors, belts, and so forth), to actuate based on the optimal parameters contained in the prescription map. For example, a plot of sensor data for certain components plotted over time indicates a first spike measurement in engine torque and a second spike measurement in mass flow rate due to increased crop harvesting. Although these two spikes should occur at the same time or at the same position in the field, in some instances, these two spikes are not measured at a similar time or position in the field due to a delay (for example, a sensor-time delay) from when the crop is harvested to when it reaches the mass flow rate sensor. Embodiments of the present disclosure remove or reduce the time delay in the sensor data to improve the generation of plots and prescription maps. Improving the generation of plots and prescription maps can help reduce emissions as the work vehicles that rely on these prescription maps can more efficiently operate, thereby reducing fuel consumption and emissions while performing farming operations.

Embodiments of the present disclosure include accessing, from a first sensor of a harvester, first sensor data comprising a first time-stamped signal indicative of a first parameter associated with farming operations, such as harvesting, performed within a field. In one example, the first sensor data includes data indicative of a mass flow rate of harvested crops, as determined by a mass flow sensor of a harvester assembly of the harvester. Embodiments of the present disclosure include accessing, from a second sensor of the harvester, second sensor data comprising a second time-stamped signal indicative of a second parameter associated with the farming operation performed within the field. In one example, the second sensor data includes data indicative of an engine torque, as determined by a machine engine torque sensor of a work vehicle of the harvester. Embodiments of the present disclosure include cross-correlating the first time-stamped signal and the second time-stamped signal. Cross-correlation refers to a digital signal processing operation whereby a similarity of the first time-stamped signal and the second time-stamped signal is measured as a function of a lag of the first time-stamped signal relative to the second time-stamped signal. In one example, cross-correlating the first time-stamped signal and the second time-stamped signal includes cross-correlating two one-dimensional signals, whereby the units of the signals are irrelevant as both signals are measured over the same units of time. In one example, the output of the cross-correlation includes a one-dimensional signal where the amplitude represents the similarity between the first time-stamped signal and the second time-stamped signal vs the time lag relative between the two signals. Cross-correlation can be applied to linear and time-invariant (LTI) systems.

Based on cross-correlating the first time-stamped signal and the second time-stamped signal, embodiments of the present disclosure include determining a time delay between the first sensor data and the second sensor data. In one example, the time delay corresponds to the difference in time between (1) the peak of the one-dimensional signal that is outputted from the cross-correlation and (2) the midway point between the sensor rage (which corresponds to the time range during which the first and second sensor signals were sampled). In some embodiments, the time delay is determined based on a time shift machine learning (ML) model.

Embodiments of the present disclosure include applying the time shift equal to the time delay to the first sensor data to automatically generate a time-invariant data set. Embodiments of the present disclosure include generating a prescription map indicative of a plan for performing tasks and work on the field based at least on the second sensor data and the time-invariant data set. Alternatively or additionally, embodiments of the present disclosure include generating, based at least on the second sensor data and the time-invariant data set, a graphical user interface comprising a plot indicative of at least one of the second sensor data or the time-invariant data set plotted against any suitable satellite positioning system data, such as global positioning (GPS) data.

This summary is intended to introduce a selection of concepts in a simplified form that is further described in the detailed description section of this disclosure. The summary is not intended to identify key or essential features of the claimed subject matter, nor is it an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1A is an example harvester, in accordance with an aspect described herein;

FIG. 1B is an example harvester system that operates the example harvester of FIG. 1B, in accordance with an aspect described herein;

FIG. 2 is a block diagram of an architecture implementing aspects of the harvester system of FIG. 1B or the harvester of FIG. 1A, in accordance with an aspect described herein;

FIG. 3 is a plurality of plots depicting results of implementing the architecture of FIG. 2 into aspects of the harvester system of FIG. 1B or the harvester of FIG. 1A, in accordance with an aspect described herein;

FIG. 4A is an uncorrected plot that is based on sensor data from the harvester;

FIG. 4B is a corrected plot that applies a time delay, in accordance with an aspect described herein;

FIG. 5 is an example method of generating a prescription map based on a time-invariant data set generated by a cross-correlation engine, in accordance with an aspect described herein;

FIG. 6 is an example method of generating a prescription map based on a time-invariant data set generated by a cross-correlation engine, in accordance with an aspect described herein;

FIG. 7 is an example method of deploying a trained ML model to automatically reduce a time delay of sensor data, in accordance with an aspect described herein;

FIG. 8 depicts results of an example embodiment of the present disclosure reduced to practice, including a machine learning model being trained and used to reduce or eliminate a time delay in sensor data;

FIG. 9 is a block diagram illustrating a computing device suitable for use with embodiments of the technology described herein; and

FIG. 10 is a block diagram of an example computing environment suitable for use in implementing aspects of the technology described herein.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, such as to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. The method(s) described herein may comprise a computing process performed using any combination of hardware, firmware, and/or software. For example, various functions are carried out by a processor executing instructions stored in memory. The methods may also be embodied as computer-useable instructions stored on computer storage media. The methods may be provided by a stand-alone application, a service or hosted service (stand-alone or in combination with another hosted service), or a plug-in to another product, to name a few.

It will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated in the accompanying drawings is to be interpreted as illustrative and not in a limiting sense.

In many industrial settings, sensors are employed to provide real-time or near real-time sensor data associated with parameters, such as parameters indicative of certain farming operations, such as crop harvesting. In these industrial settings, the sensor data is communicated to a computing device as a sensor signal. Time delays are inherent in certain dynamic systems, such as those associated with certain farming equipment. This may be especially true for farming tools that are connected to each other. For example, sensors of certain attachments, such as a harvester assembly, experience sensor time delays relative to the sensors of certain work vehicles. In some instances, the time delays are small and negligible, minimally affecting a desired output. However, in other instances, the time delays are greater and significant, causing disruptions to a desired output that is based on these sensor signals.

In the context of harvesting operations, a harvester may be equipped with certain sensors to facilitate performing harvesting operations. In one example, a harvester refers to a device, such as a work vehicle that is connected to a harvester assembly, that collects agricultural product as the harvester travels across the field. Example work vehicles include a tractor, a combine, a harvester, an all-terrain vehicle (ATV), a utility terrain vehicle (UTV), or any other vehicle that employs any suitable attachments, such as plows, harrows, fertilizer spreaders, seeders, balers, wagons, trailers, or other farming attachments. To facilitate operation, certain harvesters include sensors associated with the work vehicle or the harvester assembly. Example sensors include an engine torque sensor of the work vehicle, a mass flow sensor of the harvester assembly, and other sensors. In some embodiments, the sensor signals or sensor data of these or other sensors is used to generate a prescription map or other plots, such as a positioning map showing sensor data as a function of position on a field. In some instances, a first data from a first sensor associated with the harvester includes timing discrepancies as compared to a second data from a second sensor associated with the harvester.

As a result of these discrepancies, certain prescription maps include inaccuracies that compromise the efficiency of work vehicles relying on these prescription maps for performing future farming operations. Accordingly, discrepancies in sensor data may result in inefficient fuel consumption and higher emissions, as work vehicles actuate certain components at high levels during times of low production. For example, a work vehicle inefficiently expends power in actuating a particular component, such as an engine throttle or hydraulic piston, to attempt to achieve a desired output, such as outputting fertilizer, seeds, water, and the like. However, the desired output is never achieved due to the inaccurate prescription map and plot, which is generated based on sensor data experiencing time delays and on which the work vehicle is relying. Accordingly, targeting and reducing the effects of these time delays associated with sensor data can improve overall farming operations (for example, applying fertilizer, herbicide, or seeds; watering crops; developing the ground; and so forth), enhance crop output, increase operational efficiency of work vehicles, and reduce fuel consumption and emissions. However, certain existing technologies fail to adequately address this problem in any manner, much less in a computational, inexpensive manner that can be scaled across the ever-increasing number of work vehicles tasked with efficiently performing farming operations for an exponentially increasing human population.

With this in mind, embodiments of the present disclosure include performing technical operations on sensor data to determine and apply a time offset to sensor data experiencing timing delays that affect the accuracy of prescription maps and other plots relied on by technicians and computing systems to perform farming operations. In one example, a population map refers to a file that defines operating parameters for certain components of a machine operating in certain positions (or geographic coordinates) within a field. In the context of a harvester operating on the field, a computing device associated with the harvester accesses and processes the prescription map to instruct components of the harvester, such as the engine of the work vehicle and actuators of the harvester assembly (for example controlling a header, reel, cutter bar, sieves, rotating blades, unloading pipe, augers, conveyors, belts, and so forth), to actuate based on the optimal parameters contained in the prescription map. In one example, the “optimal parameters” refers to parameters determined by a computing device to result in the highest or lowest output, which, in the context of a harvester, includes the highest mass flow rate for the least engine output.

In some instances, these optimal parameters may be inaccurate due to time delays in the sensor data used to determine the optimal parameters. For example, a first plot of sensor data associated with engine torque includes a first spike measurement for engine torque at a first time, and a second plot of second sensor data associated with mass flow rate includes a second spike measurement for mass flow rate at a second time. Although these two spikes should occur at the same time or at the same position on the field, these two spikes are determined to occur at different positions in the field or different times of operation due to a time delay. Embodiments of the present disclosure remove or reduce the time delay in the sensor data to improve the operational efficiency of work vehicles whose operations are at least partially based on plots or prescription maps generated based on the sensor data. Improving the generation of plots and prescription maps can help reduce emissions since the work vehicles that rely on these prescription maps can more efficiently operate, thereby reducing fuel consumption and emissions while performing farming operations.

Embodiments of the present disclosure include accessing, from a first sensor of a harvester, first sensor data comprising a first time-stamped signal indicative of a first parameter associated with farming operations, such as harvesting, performed within a field. In one example, the first sensor data includes data indicative of a mass flow rate of harvested crops, as determined by a mass flow sensor. Embodiments of the present disclosure include accessing, from a second sensor of the harvester, second sensor data comprising a second time-stamped signal indicative of a second parameter associated with the farming operation performed within the field. In one example, the second sensor data includes data indicative of an engine torque, as determined by a machine engine torque sensor. Embodiments of the present disclosure include cross-correlating the first time-stamped signal and the second time-stamped signal. In one example, cross-correlation refers to a digital signal processing operation whereby a similarity of the first time-stamped signal and the second time-stamped signal is measured as a function of a lag of the first time-stamped signal relative to the second time-stamped signal. In one example, cross-correlating the first time-stamped signal and the second time-stamped signal includes cross-correlating two one-dimensional signals, whereby the units of the signals are irrelevant as both signals are measured over the same units of time. In one example, the output of the cross-correlation includes a one-dimensional signal where the amplitude represents the similarity between the first time-stamped signal and the second time-stamped signal.

It will be realized that the systems and methods previously described are only examples that can be practiced from the description that follows, which is provided to understand the technology and recognize its benefits more easily. Additional examples are now described with reference to the figures.

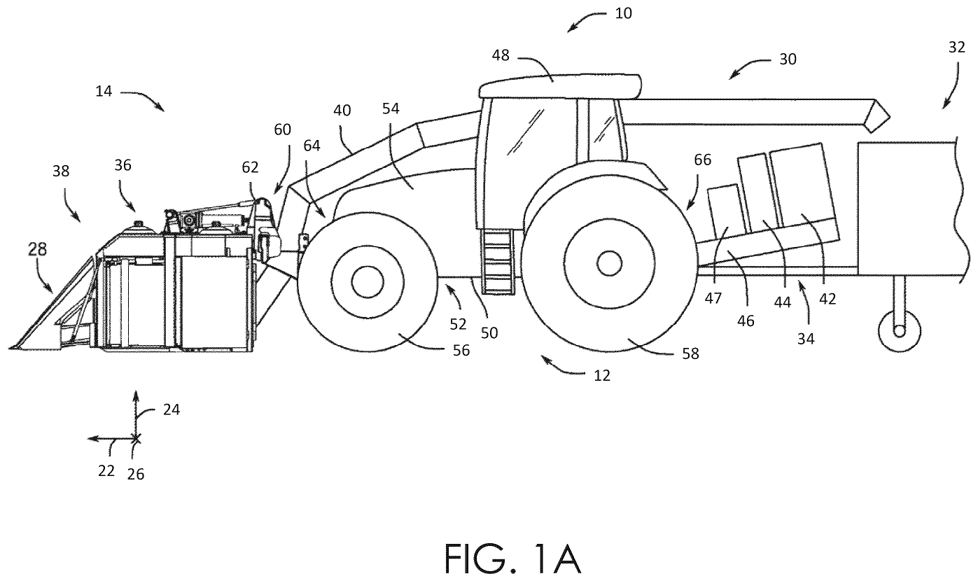

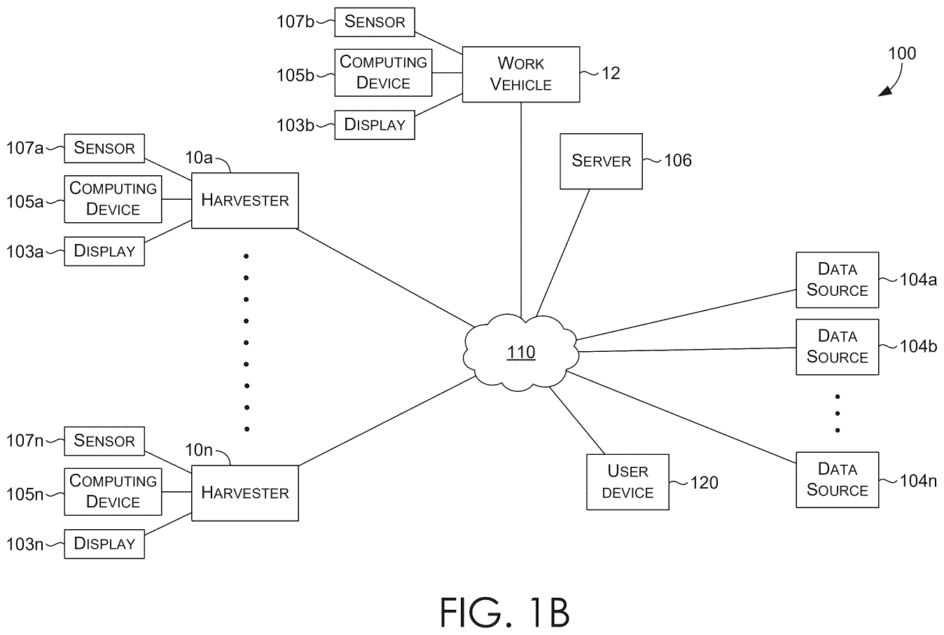

Referencing FIG. 1A, a perspective view of an example harvester 10 is illustrated. As illustrated, the harvester 10 combines two main pieces of equipment, a work vehicle 12 (e.g., tractor assembly or tractor) and a harvester assembly 14. To facilitate the discussion, aspects of the harvester 10 and its components are described with reference to a coordinate system 20 defining a longitudinal axis or direction 22, a vertical axis or direction 24, and a lateral axis or direction 26. By attaching the harvester assembly 14 to the work vehicle 12, the work vehicle 12 is able to be used both as a harvester and for other jobs or agricultural tasks. As illustrated, the example harvester assembly 14 includes a harvester attachment 28, a transport system 30, a bin 32, and a support system 34.

As shown, the harvester attachment 28 includes multiple drum assemblies 36 (e.g., harvesting heads) and plant lifters 38. In operation, the plant lifters 38 lift the stems, branches, and so forth, of the plant for harvesting by the drum assemblies 36. The drum assemblies 36 harvest the cotton using one or more rotors to separate the cotton from other agricultural materials (e.g., chaff, foliage, stems, or debris). The harvester attachment 28 may have any suitable number of drum assemblies 36, such as 1, 2, 3, 4, 5, 6, or more drum assemblies 36. In some embodiments, the harvester attachment 28 includes a drive system (e.g., pulley system) that drives the multiple drum assemblies 36, a blower, and/or other components.

In order to transfer the harvested goods from the harvester attachment 28, the harvester assembly 14 includes the transport system 30 that includes a blower (e.g., fan) that is configured to blow air that directs the harvested goods through one or more conduits 40 to a bin 32 (e.g., basket or baler). In some embodiments, the transport system 30 is configured to move (e.g., pivot or rotate) to transfer the harvested goods from the harvester attachment 28 to another container or onto a field. In some embodiments, the residual agricultural materials are deposited onto the agricultural field beneath and/or behind the harvester attachment 28.

The support system 34 supports the operation of the harvester attachment 28. For example, the support system 34 includes a hydraulic pump 42 that fluidly couples to the harvester attachment 28 (e.g., hydraulic lines or conduits). In operation, some embodiments of the hydraulic pump 42 provide hydraulic pressure to lift the harvester attachment 28 and drive the drum assemblies 36, among other components. In some embodiments, the hydraulic pump 42 may be a power take-off hydraulic pump 42, which receives its power directly from the work vehicle 12. The support system 34 may also include a fluid tank 44. The fluid tank 44 may provide lubricating and/or cleaning fluid (e.g., water) to the harvester attachment 28 to facilitate harvesting operations. The hydraulic pump 42 and fluid tank 44 may be supported on a platform 46. The platform 46 couples to and uncouples from the work vehicle 12, enabling the work vehicle 12 to be transformed into a harvester 10. In some embodiments, the support system 34 may include a motor 47 for powering the hydraulic pump 42 and/or other pumps (e.g., a pump that pumps fluid from the fluid tank 44). The motor 47 may also be used to power blowers or fans that transport agricultural product (e.g., cotton) from the harvester attachment 28 to the bin 32.

As illustrated, the work vehicle 12 may include a cabin 48 to support or house an operator. It should be understood that the cabin 48 may be an enclosed cabin (e.g., a climate-controlled cabin), as shown, or the cabin 48 may be a platform (e.g., open or non-enclosed platform) on which the operator may sit or stand, for example. In the illustrated embodiment, the cabin 48 includes one or more operator interfaces and/or input devices 50 (e.g., switch, knob, light, display, steering wheel, gear shift lever, or touch screen) that enables the operator to monitor and/or control various functions of the harvester attachment 28 and the work vehicle 12. As shown, the cabin 48 is supported on a chassis 52. In addition to supporting the cabin 48, the chassis 52 supports an engine 54, a fuel system, hydraulic systems, transmission, radiator, and HVAC system, among others. The chassis 52 is supported by front wheels 56 and rear wheels 58. In some embodiments, the work vehicle 12 may include tracks in place of the front wheels 56 and/or rear wheels 58.

As explained above, the harvester assembly 14 or conversion kit couples to the work vehicle 12 to create or build the harvester 10. Thus, at certain times of the year, the operator may utilize the work vehicle 12 to carry out various agricultural operations. However, during a harvesting season, the operator may separate the work vehicle 12 from other equipment, and then couple the harvester assembly 14 to the work vehicle 12 to form the harvester 10. At the conclusion of the harvesting season, the operator may again separate the work vehicle 12 from the harvester assembly 14 to perform other tasks.

To facilitate the coupling and uncoupling of the harvester assembly 14 to and from the work vehicle 12, the harvester assembly 14 may include one or more quick connectors. The quick connectors enable rapid assembly and disassembly of the harvester 10. For example, the harvester attachment 28 may include a quick connector 60. The quick connector 60 may be a three-point connector that enables the rapid coupling and uncoupling of the tool bar 62 to the work vehicle 12. For example, the quick connector 60 may enable coupling to a three-point hitch 64 on the work vehicle 12. Similarly, the support system 34 may couple to the work vehicle 12 with a quick connector 66. The quick connector 66 may similarly be a three-point connector, which couples the platform 46 to a three-point hitch on the work vehicle 12. The bin 32 similarly couples to the work vehicle 12. In some embodiments, the bin 32 may couple to the work vehicle 12 with a quick connector (e.g., three-point connector) or may couple to a standard hitch on the work vehicle 12.

FIG. 1B is a block diagram of an example harvester system 100 in which the example harvester 10 of FIG. 1B operates, in accordance with an aspect described herein. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. For example, it should be understood that the components illustrated in FIG. 1B can wirelessly communicate with each other by way of any suitable hardware and protocol, such as a transceiver employing a protocol, such as Wi-Fi, Bluetooth, Zigbee, Z-wave, 6LowPAN (IPv6 Low-power Wireless Personal Area Network), Radio-Frequency Identification (RFID), and so forth. In certain embodiments, certain components are communicatively coupled via wired connection. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor or processing circuitry executing instructions stored in memory.

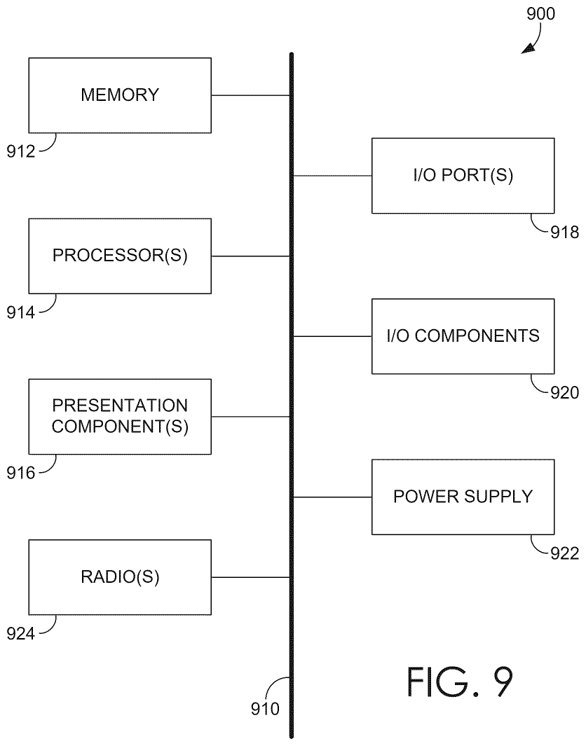

Among other components not shown, example harvester system 100 includes a number of devices, such as harvester 10a and 10b through 10n; displays 103a and 103b through 103n; a number of data sources, such as data sources 104a and 104b through 104n; a number of computing devices, such as computing devices 105a and 105b through 105n; server 106; sensors, such as sensors 107a and 107b through 107n; network 110; user device 120; and work vehicle 12. It should be understood that harvester system 100 as shown in FIG. 1 is an example of one suitable operating environment. Any or each of the components shown in FIG. 1 may be implemented via any type of hardware component having a computing device, such as computing device 900 as described in connection to FIG. 9, for example. These components may communicate with each other via network 110, which may include, without limitation, one or more local area networks (LANs) and/or wide area networks (WANs). In some implementations, network 110 comprises the Internet and/or a cellular network, amongst any of a variety of possible public and/or private networks employing any suitable communication protocol.

It should be understood that any number of work vehicles 12, sensors 107, servers 106, and data sources 104 may be employed within harvester system 100 within the scope of the present disclosure. Example work vehicles 12 include a tractor, a combine, a harvester (such as harvester 10), an all-terrain vehicle (ATV), a utility terrain vehicle (UTV), or any other vehicle that employs any suitable attachments, such as plows, harrows, fertilizer spreaders, seeders, balers, wagons, trailers, or other farming attachments. In some embodiments, the illustrated components comprise a single device or multiple devices cooperating in a distributed environment. For instance, server 106 is provided via multiple devices arranged in a distributed environment that collectively provide the functionality described herein. Additionally, other components not shown may also be included within the distributed environment.

The computing devices 105 of harvesters 10a and 10b through 10n can be client devices on the client-side of harvester system 100, while server 106 can be on the server-side of harvester system 100. Server 106 can comprise server-side software designed to work in conjunction with client-side software on computing devices 105 of harvesters 10 and work vehicle 12 to implement any combination of the embodiments and functionalities discussed in the present disclosure. This division of harvester system 100 is provided to illustrate one example of a suitable environment, and there is no requirement for each implementation that any combination of server 106 and user devices 10a and 10b through 10n remain as separate entities. In one embodiment, the displays 103a and 103b through 103n are touchscreen displays. The displays 103a and 103b through 103n may be integrated into the harvester 10a and 10b through 10n, the work vehicle 12, and/or the user device 120.

In more detail, certain embodiments of user device 120 comprise any type of computing device capable of use by a user. For example, in one embodiment, user device 120 includes a computing device 900 described in relation to FIG. 9. By way of example and not limitation, a user device 120 is embodied as a personal computer (PC), a laptop computer, a mobile device, a smartphone, a tablet computer, a smart watch, a wearable computer, a personal digital assistant (PDA), a music player or an MP3 player, a satellite positioning system (such as a global positioning system (GPS) or device), a video player, a handheld communications device, a gaming device or system, an entertainment system, a vehicle computer system, an embedded system controller, a camera, a remote control, a bar code scanner, a computerized measuring device, an appliance, a consumer electronic device, a workstation, any combination of these delineated devices, or any other suitable computer device. In operation, a user device 120 may be communicatively coupled to the harvester 10a and 10b through 10n, the work vehicle 12, or any suitable device to control farming operations or receive data indicative of farming operations.

In some embodiments, this data indicative of farming operations is determined or detected via any number of sensors 107. In some embodiments, the sensors 107 are insulated and enclosed to block debris associated with certain farming operations. Certain embodiments of the harvesters 10a through 10n include any suitable sensor to enhance farm operations on a field, such as an engine torque sensor, an engine force sensor, a mass flow sensor, a downforce sensor, a harvest yield baler sensor, a wheel force sensor, a soil compactions sensor, a dielectric soil moisture sensor, a camera, and other sensors.

In one example, an engine torque sensor includes any suitable sensor, such as a magnetoelastic torque sensor, to measure a torque output of the engine 54 (FIG. 1A) of the harvesters 10 or the work vehicle 12. In one example, an “engine force sensors” includes any suitable sensor, such as a magnetoelastic torque sensor, to measure a force output by the engine 54 (FIG. 1A) of the harvesters 10 or the work vehicle 12. In one example, a downforce sensor includes any suitable sensor to measure a hydraulic force being exerted on a component, such as those described above in FIG. 1A, of the harvester 10 or work vehicle 12. In one example, a harvest yield baler sensor includes any suitable sensor to measure properties of a hay bale being assembled by the harvester, including but not limited to a consistency, density, moisture level, size, volume, and so forth, of a hay bale. In one example, a wheel force sensor includes any suitable sensor to measure a force exerted on a tire or a suspension of a tire to determine a total downward load exerted on the harvester or work vehicle. In one example, soil compaction sensors include an electrochemical sensor that provides information indicative of soil nutrients, ions (such as nitrate, potassium, or hydrogen), or other suitable information. In one example, the dielectric soil moisture sensors include a sensor that provides information of moisture levels in the soil based on rain check locations around a field. In one example, “cameras” includes any device (e.g., a monocular camera, a compact camera, a bridge camera, or a mirrorless camera) capable of recording visual images (e.g., two-dimensional images) in the form of photographs, film, video signals, and so forth, to generate a stream of video.

These sensors are included as a non-exclusive list of examples, as it should be understood that additional or alternative sensors may be employed in certain embodiments.

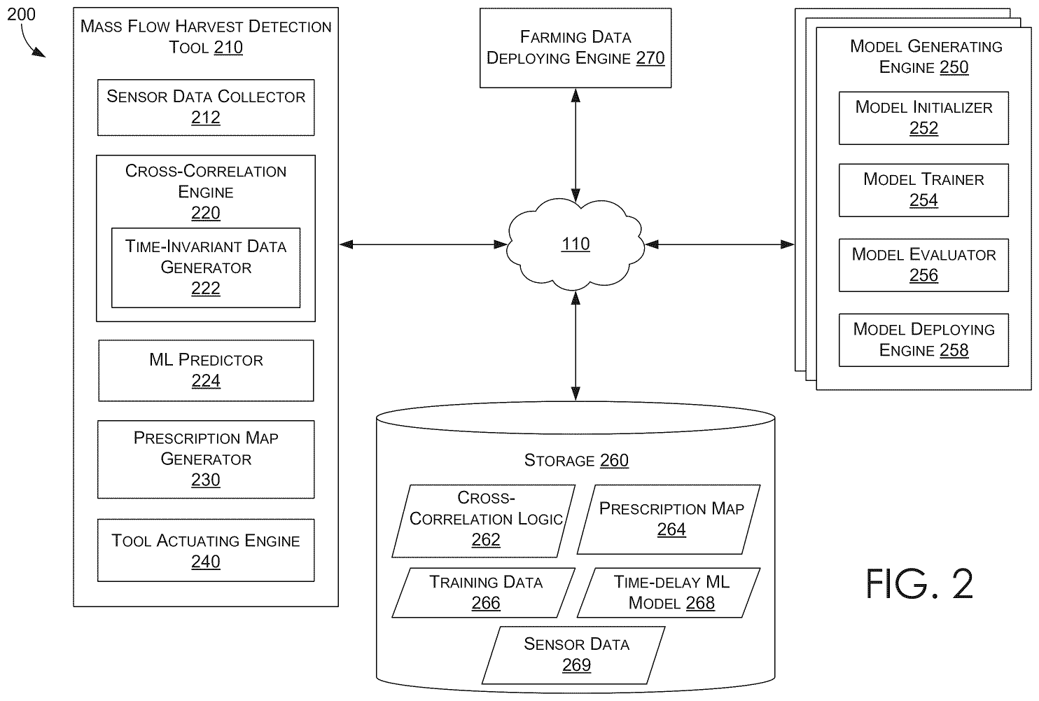

Data sources 104a and 104b through 104n may comprise data sources and/or data systems, which are configured to make data available to any of the various constituents of harvester system 100 or system 200 described in connection to FIG. 2. For instance, one or more data sources 104a through 104n provide (or make available for accessing) the sensor data determined by sensor 107, the prescription map generated based on the time-invariant data determined by the cross-correlation engine 220 of FIG. 2, the ML model generated by the ML predictor 224, the prescription map generated by the prescription map generator 230, or any other data disclosed herein.

In one embodiment, the data sources 104a and 104b through 104n are discrete from harvesters 10a through 10n, work vehicle 12, user device 120, and server 106. Alternatively, the data sources 104a through 104n may be incorporated and/or integrated into at least one of those components. In one embodiment, one or more of data sources 104a through 104n may be integrated into, associated with, and/or accessible to one or more of the harvesters 10a through 10n, work vehicle 12, user device 120, or server 106. Examples of computations performed by harvesters 10a through 10n, work vehicle 12, user device 120, and/or server 106, and/or examples of corresponding data made available by data sources 104a through 104n are described further in connection to system 200 of FIG. 2.

In one embodiment, one or more of data sources 104a through 104n store data received by computing device 105, displays 103, or sensors 107, which may be integrated into or associated with one or more of the harvesters 10a through 10n, work vehicle 12, user device 120, or server 106. Examples of data made available by data sources 104a through 104n are described further in connection to sensor data collector 212 of FIG. 2.

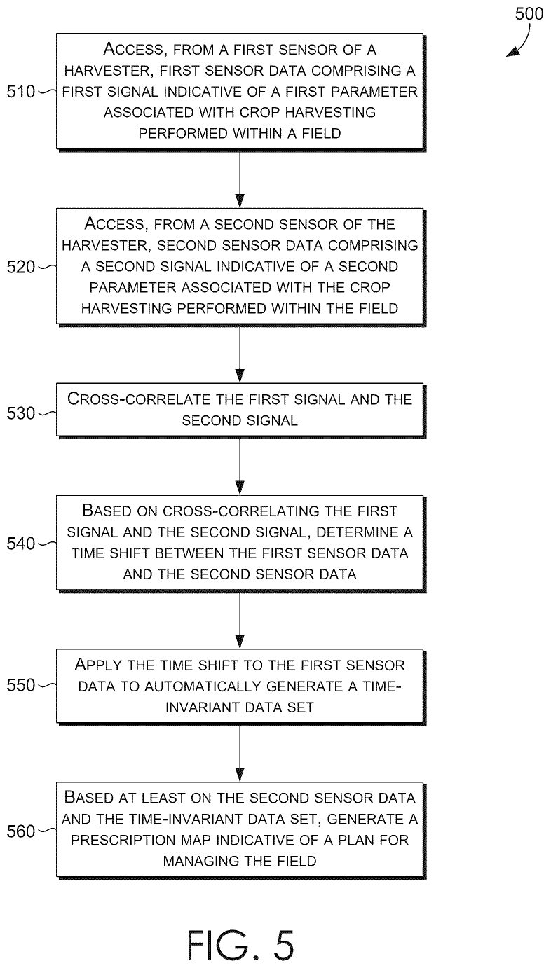

Harvester system 100 can be utilized to implement one or more of the components of system 200, as described in association with FIG. 2. Harvester system 100 also can be utilized for implementing aspects of process flows 500, 600, and 700 as described in FIGS. 5, 6, and 7, respectively. Turning to FIG. 2, depicted is a block diagram illustrating an example system 200 in which some embodiments of this disclosure are employed. System 200 represents only one example of a suitable computing system architecture. Other arrangements and elements can be used in addition to or instead of those shown, and some elements may be omitted altogether for the sake of clarity. Further, as with harvester system 100, many of the elements described herein are functional entities that may be implemented as discrete or distributed components or in conjunction with other components, and in any suitable combination and location.

Example system 200 includes a network 110, which is described in connection to FIG. 1, and which communicatively couples components of system 200 including mass flow harvest detection tool 210 (which includes sensor data collector 212, cross-correlation engine 220, time-invariant data generator 222, machine learning [ML] predictor 224, prescription map generator 230, and tool actuating engine 240), model generating engine 250 (which includes model initializer 252, model trainer 254, model evaluator 256, and model deploying engine 258), and storage 260 (which includes cross-correlation logic 262, prescription map 264, training data 266, time-delay ML model 268, and sensor data 269), and farming data deploying engine 270. The mass flow harvest detection tool 210 and the model generating engine 250 may be embodied as a set of compiled computer instructions or functions, program modules, computer software services, or an arrangement of processes carried out on one or more computer systems, such as computing device 900, as described in connection to FIG. 9, for example.

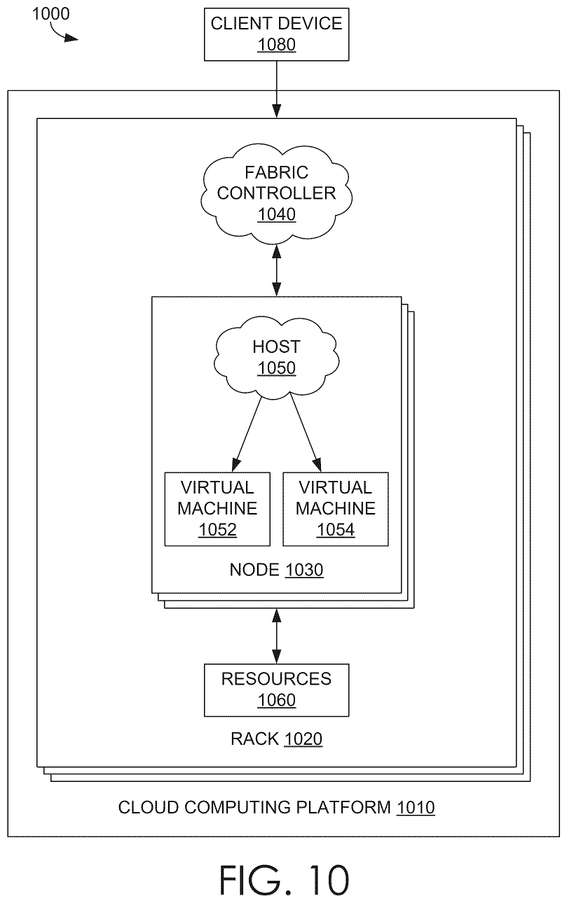

In one embodiment, the functions performed by components of system 200 are associated with one or more applications, services, or routines. In one embodiment, certain applications, services, or routines operate on one or more user devices (such as user device 120), one or more servers (such as server 106), are distributed across one or more user devices and servers, or are implemented in a cloud-based system, such as that illustrated in FIG. 10. Moreover, in some embodiments, these components of system 200 are distributed across a network, including one or more servers (such as server 106 of FIG. 1), client devices (such as user device 120), in the cloud, on a user device (such as user device 120), on the harvester 10 (FIG. 1), or the work vehicle 12 (FIG. 1). Moreover, certain components and/or functions performed by these components, or services carried out by these components, may be implemented at appropriate abstraction layer(s) of the computing system(s), such as the operating system layer, application layer, hardware layer, and so forth. Alternatively, or in addition, the functionality of these components and/or the embodiments of the disclosure described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so forth. Additionally, although functionality is described herein with reference to specific components shown in example system 200, it is contemplated that in some embodiments functionality of these components can be shared or distributed across other components.

Continuing with FIG. 2, the mass flow harvest detection tool 210 is generally responsible for receiving sensor data, cross-correlating the sensor data, and generating a prescription map, among other tasks, as described herein. Reducing time delays between sensor data by cross-correlating the sensor data results in more accurate prescription maps and plots, as the underlying data used to generate those prescription maps and plots are improved. In this manner, the effects of these time delays associated with sensor data is reduced or altogether eliminated. As a result, certain farming operations (for example, applying fertilizer, herbicide, or seeds; watering crops; developing the ground; and so forth) relying on this sensor data for future farming are improved, certain crop output is enhanced, the operational efficiency of certain work vehicles is increased, and fuel consumption and emissions may be reduced. In some embodiments, time delay reduction between sensor data is achieved in a computationally inexpensive manner (e.g., employing computationally inexpensive machine learning techniques or a cross-correlation numerical method of one-dimensional sensor signals) while reducing errors and expenses associated with having a dedicated person manually estimate and manually apply a time shift to sensor data. Such manual approach may be inaccurate due to the speculative nature of estimating such delays across various farming operations.

Continuing with FIG. 2, the sensor data collector 212 of the mass flow harvest detection tool 210 is generally configured to receive or access a sensor data 269, for example, associated with sensor 107 (FIG. 1). In some embodiments, the sensor data collector 212 receives sensor data over a length of time to generate a sensor signal. In the context of farm operations, the sensor signal may be indicative of a farming operation performed on the field. In some embodiments, the sensor data collector 212 stores the sensor data 269 in storage 260 where the sensor data 269 is accessible to other components of system 200, among other components.

In some embodiments, the sensor data collector 212 stores the sensor data 269 based on corresponding timestamps. For example, the sensor data collector 212 receives raw sensor signals and extracts sensor data over a period of time. In this manner, the sensor data can be compared against other sensor data over a similar period of time. To help illustrate, suppose the sensor data collector 212 receives a first sensor signal from t₁ to t₂ and receives a second sensor signal from t₃ to t₄, such that the period of time t₃ through t₄ is contained in the period of time t₁ through t₂. By storing the sensor data 269 associated with the first sensor signal and the second sensor signal, the second sensor signal can be compared to the first sensor signal at the portion of time during which the first and second sensor signals overlap, which in this example is the second time-stamped signal being compared to the portion of the first time-stamped signal that overlaps the period of time t₃ through t₄.

Continuing with FIG. 2, the cross-correlation engine 220 is generally configured with cross-correlation logic 262 for cross-correlating two sensor signals. For example, the cross-correlation engine 220 accesses the two signals as the sensor data 269 from storage 260. As described herein, cross-correlation (also called a “sliding dot product” or a “sliding inner product”) refers to a digital signal processing operation whereby a similarity of the first time-stamped signal and the second time-stamped signal is measured as a function of a lag of the first time-stamped signal relative to the second time-stamped signal.

By way of non-limiting examples of the cross-correlation engine 220 employing cross-correlation logic 262, suppose a first time-stamped signal of first sensor data is represented by g and a second time-stamped signal of second sensor data is represented by f, then the cross-correlation, *, can be defined as:

$$( f * g ) ( τ ) {=}^{△} {\int }_{- ∞}^{∞} \overline{f ( t )} g ( t + τ ) dt \qquad ( 1 )$$

Which is equivalent to:

$$( f * g ) ( τ ) {=}^{△} {\int }_{- ∞}^{∞} \overline{f ( t - τ )} g ( t ) dt \qquad ( 2 )$$

In this example, f̅(̅t̅)̅ denotes the complex conjugate of f(t), and τ denotes the time lag (also called “displacement”). For highly correlated f and g, which have a maximum cross-correlation at a particular τ, a feature in f at t also occurs late in g at t+τ. Therefore, g can be described to lag f by τ. In one example discussed herein, the lag corresponds to the time delay.

Now, suppose f and g are both continuous periodic functions of period T, the integrations from −∞ to ∞ can be replaced by integration over any interval [t₀, t₀+T] of length T. The cross-correlation can be defined as:

$$( f * g ) ( τ ) {=}^{△} {\int }_{{c}_{0}}^{{t}_{0} + T} \overline{f ( t )} g ( t + τ ) dt \qquad ( 3 )$$

Which is equivalent to:

$$( f * g ) ( τ ) {=}^{△} {\int }_{{t}_{0}}^{{t}_{0} + T} \overline{f ( t - τ )} g ( t ) dt \qquad ( 4 )$$

Based on the cross-correlation, embodiments of the cross-correlation engine 220 determine the time delay between two signals, τ_{delay}, using the equation:

$${τ}_{delay} = {arg max}_{t ∈ ℝ} ( ( f * g ) ( t ) ) \qquad ( 5 )$$

That is, after the cross-correlation engine 220 calculates the cross-correlation between the two signals, the maximum (or minimum, if the signals are negatively correlated) of the cross-correlation function indicates the point in time where the signals are best aligned. In this manner, the time delay between the two signals is determined by the argument of the maximum, or arg max of the cross-correlation, as in equation 5.

In one example, cross-correlating the first time-stamped signal and the second time-stamped signal includes cross-correlating two one-dimensional signals, whereby the units of the signals are irrelevant as both signals are measured over the same units of time. In one example, the output of the cross-correlation includes a one-dimensional signal where the amplitude represents the similarity between the first time-stamped signal and the second time-stamped signal, as discussed above.

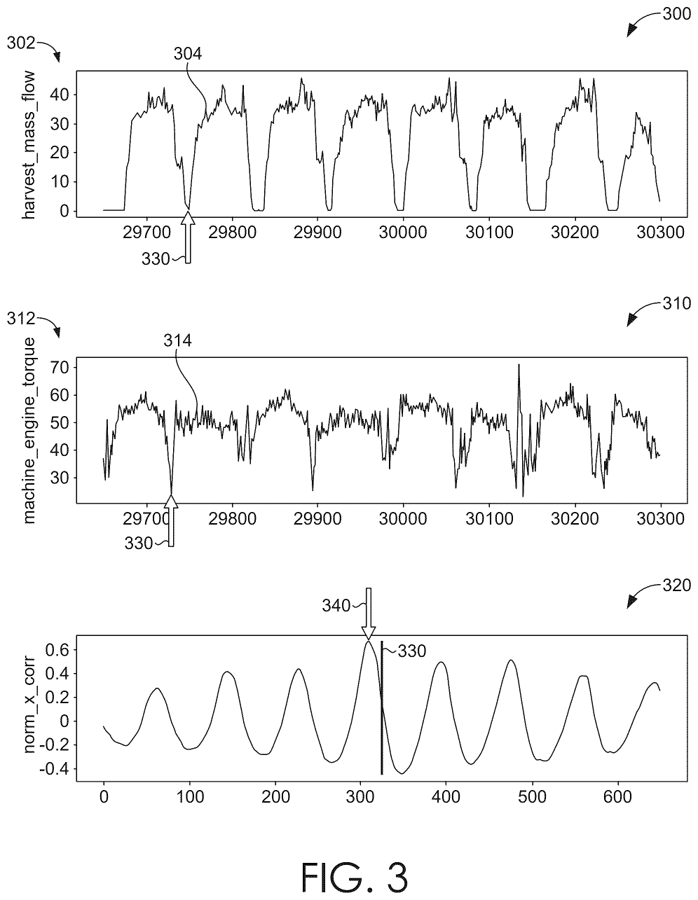

Continuing the format and variables discussed above, the first sensor signal, g, may delay the second time-stamped signal, f. In one example, the first sensor signal corresponds to a first sensor signal indicative of a mass flow rate of harvested crops flowing through the harvester assembly 14 (FIG. 1A) as determined by a first sensor, such as a mass flow rate sensor, and the second sensor signal corresponds to a second sensor signal indicative of an engine torque of the harvester 10 (or work vehicle 12) (FIG. 1A) as determined by a first sensor, such as an engine torque sensor. In this example, the first sensor signal, g, lags the second sensor signal, f, by lag τ. An example of this lag is depicted in FIG. 3.

Continuing with FIG. 2, the time-invariant data generator 222 is generally configured with cross-correlation logic 262 to apply the τ_{delay} to the sensor signal having the lag, which in the example above is the first sensor signal, g, which may delay the second time-stamped signal, f. In one embodiment, after the cross-correlation engine 220 determines the time delay between two signals, τ_{delay} (for example, using equation 5), then the time-invariant data generator 222 applies the time delay, τ_{delay}, to generate time-invariant data. As used herein and in one example, “time-invariant” data refers to a time shift equal to the time delay, τ_{delay}, being applied to the sensor data that is experiencing a time delay. In one embodiment, applying the time delay to the sensor data includes offsetting the sensor data so that the sensor signal is offset forward to a time equal to the time delay with or without further adjusting the amplitude, height, or other wave parameters of the sensor signal.

Continuing the example above, since the first sensor signal, g, delays the second time-stamped signal, f, the time-invariant data generator 222 applies the time delay, τ_{delay}, determined by the cross-correlation engine 220 to generate time-invariant data. In this example, the time-invariant data includes the first sensor signal, g, having the time change so that the corresponding sensor signal appears as having occurred at an earlier time, which is equal to the duration of the time delay, τ_{delay}. In this manner, the timing of the first sensor signal, stored as time-invariant data, may more closely match the actual timing of the second sensor.

In some embodiments, the time-invariant data generator 222 replaces the sensor data experiencing the delay with the time-invariant data. Continuing the example above, the time-invariant data generator 222 replaces in the storage 260 the first sensor data, g, with the time-invariant data, which includes the first sensor data, g, applied the time delay, τ_{delay}. In this example, the first sensor data, g, is replaced with the time-invariant data in the sensor data 269 of the storage 260. However, in some embodiments, the time-invariant data in the sensor data 269 of the storage 260 is stored alongside the first sensor data, g, as sensor data 269 in storage 260. Although this example is discussed in the context of a time shift being applied to sensor data that is delayed relative to another sensor data, it should be understood that in some embodiments, the time shift may be applied to the sensor data that is ahead (not delayed) relative to another sensor data. In either case, embodiments of the present disclosure cross-correlate at least two sensors' data to reduce effects of time differences between the data of these two sensors.

Continuing with FIG. 2, the ML predictor 224 is configured with computing logic, such as the logic contained in the time-delay ML model 268, to predict a time delay associated with sensor data obtained by sensor data collector 212. It should be understood that, in some embodiments, the ML predictor 224 (instead of or in addition to the cross-correlation engine 220) may determine the time delay. The ML predictor 224 may predict the time delay based on the time-delay ML model 268. In some embodiments, the ML predictor 224 predicts a time delay based on sensor data 269. For example, the time-invariant data generator 222 employs any suitable prediction methodology, such as a classification methodology, a clustering methodology, a forecasting methodology, and an outlier's methodology to determine the time delay between two sensors' data. In some embodiments, the ML predictor 224 employs the time-delay ML model 268 that is trained and generated by the model generating engine 250. Example trained time-delay ML models include a deep learning model, a neural network model (such as a Region-based Convolutional Neural Network (R-CNN) model), a logistic regression model, a support vector machine model, and the like. Example machine learning models include a plurality of ML model layers have many kinds of parameters, activation functions, and methods. The methods within each layer can be any combination of convolution, pooling, normalization, fully connected, transformer, or any other layer method used in the field of ML. In one embodiment, the time-delay ML model 268 is a deep ML model if it has multiple layers.

Embodiments of the ML predictor 224 determine the time delay based on the time-delay ML model 268 being trained based on a set of ML features. The ML predictor 224 may be configured with computing logic, such as that associated with the time-delay ML model 268, to determine and generate ML features that may be used to train the ML model. In one embodiment, the ML predictor 224 determines the ML feature used to train the machine learning model via any suitable process. For example, the ML predictor 224 determines the ML feature via any suitable engineering process, which may include at least one of the following steps: brainstorming or testing features, deciding which features to create, creating the features, testing the impact of the created features on an object or training data, and iteratively improving features. The ML predictor 224 may generate an ML feature from labeled sensor data using any suitable computations, including, but not limited to, (1) numerical transformation (e.g., taking fractions or scaling), (2) employing a category encoder to categorize data, (3) clustering techniques, (4) group aggregation values, (5) principal component analysis, and the like. In some embodiments, the ML predictor 224 may assign different levels of significance to the labeled sensor data, such that certain corresponding ML features that have a higher level of significance are weighted accordingly when the model trainer 254 trains the ML model. In this manner, the model trainer 254 may prioritize and/or rank ML features to improve the determination of the time delay.

Taking the example set forth above of first sensor data of a mass flow rate and second sensor data of an engine torque, the ML predictor 224 can extract ML features from these sensor data. For example, the ML predictor extracts (1) from the first sensor data a first machine learning (ML) feature indicative of a first parameter, such as mass flow rate, associated with crop harvesting performed within a field, and (2) from the second sensor data a second machine learning feature indicative of a second parameter, such as engine torque, associated with the crop harvesting performed within the field. The extracted ML features may be indexed based on a time of occurrence defined in the sensor data. In one embodiment, the extracted ML features are formatted (for example, as a feature vector) using any suitable feature engineering technique. In this manner, the extracted ML features, such as those described herein, are efficiently consumed by the time-delay ML model 268, for example, to initialize, train, validate, or deploy the time-delay ML model 268.

Continuing with FIG. 2, embodiments of the prescription map generator 230 are configured with computing logic to generate a prescription map 264 based on other components of the mass flow harvest detection tool 210. As discussed herein, in one example, a prescription map refers to a file that includes operating parameters for certain components of a machine operating in certain positions (or geographic coordinates) within a field. In one example, the prescription map 264 communicates to a computing device how much product to apply based on the location of the equipment within the field. In some embodiments, the prescription map generator 230 generates prescription maps 264 based on the sensor data 269 and/or the time-delay ML model 268 being employed by the ML predictor 224. For example, first sensor data provides an indication of a mass flow rate associated with a harvester 10 and second sensor data provides an indication of engine torque associated with the harvester 10, such that one would expect the torque to be high during times when the mass flow rate is high due to the harvester traveling through an area having a high volume of crops being harvested. A delay in sensor data may create uncertainty as to where the portions of high crop volumes are concentrated, resulting in inaccurate prescription maps that prevent accurate plans for future fertilizing, seeding, and harvesting.

In some embodiments, the prescription map generator 230 may determine optimal operating parameters for the harvester 10 at certain positions along the field or at different times during operation. In one embodiment, the prescription map generator 230 stores the prescription maps 264 in storage 260. In the context of a prescription map generated for a harvester operating on the field, the prescription map may include computer-readable instructions defining an output or actuation of certain components of the harvester 10, such as those components illustrated in FIG. 1A. For example, the prescription map may define operation for components, such as the engine 54 (FIG. 1A) of the work vehicle 12 and actuators of the work vehicle 12 or any suitable attachments, assemblies, or components (for example controlling a header, reel, cutter bar, sieves, rotating blades, unloading pipe, augers, seed roller, conveyors, belts, and so forth) to actuate based on the optimal parameters contained in the prescription map.

In some embodiments, the prescription map generator 230 generates prescription maps based on the sensor data 269. Absent the embodiments discussed herein, the prescription maps would be generated based on erroneous sensor data that experiences time delays. By reducing or altogether removing the time delay of the sensor data 269, as discussed with respect to the cross-correlation engine 220 and ML predictor 224, the prescription maps generated by the prescription map generator 230 are more accurate. In some embodiments, the prescription maps 264 generated based on the time-invariant data and other sensor data 269 are more accurate than those generated by existing systems because the prescription maps 264 generated by the prescription map generator 230 are based on sensor data that has improved sensor data—namely, time-invariant data.

Embodiments of the prescription map generator 230 generate prescription maps 264 that are used in various farming contexts. In some embodiments, the prescription maps 264 are accessed by the tool actuating engine 240. Continuing with FIG. 2, embodiments of the tool actuating engine 240 are configured with computing logic to actuate components of the work vehicle 12, such as those components described with respect to FIG. 1A, among other components, based on the prescription maps 264 generated by the prescription map generator 230. In some embodiments, the tool actuating engine 240 is configured to communicate with actuators to achieve a desired output or motion at or near real-time. For example, the tool actuating engine 240 accesses the prescription maps 264 to cause corresponding actuators of target components to actuate at certain positions on the field or at certain times during operation based on the prescription map 264. In one example, the tool actuating engine 240 actuates a first component, such as a seeder or fertilizing mechanism in areas of field associated with a prior high mass flow rate as compared to other portions of the field associated with a prior low mass flow rate, as indicated by the sensor data 269 used to generate the prescription map 264 by the prescription map generator 230.

In some embodiments, the tool actuating engine 240 communicates with any suitable component of a work vehicle 12 or other device operating on or proximate to a field. In one embodiment, the tool actuating engine 240 communicates via those components via any suitable component or actuator, as described below with respect to the farming data deploying engine 270.

Continuing with FIG. 2, the model generating engine 250 may train and generate a machine learning model (e.g., the time-delay ML model 268) that may be employed by the mass flow harvest detection tool 210. The model initializer 252 may select and initialize the time-delay ML model 268. Initializing the time-delay ML model 268 may include causing the model initializer 252 to determine model parameters and provide initial conditions for the model parameters. In one embodiment, the initial conditions for the model parameters may include a coefficient for the model parameter.

The model trainer 254 may train the time-delay ML model 268 determined by the model initializer 252. As part of training the time-delay ML model 268, the model trainer 254 may receive outputs from the model initializer 252 to train the time-delay ML model 268. In some embodiments, the model trainer 254 receives the type of machine learning methodology, the loss function associated with the time-delay ML model 268, the parameters used to train the time-delay ML model 268, and the initial conditions for the model parameters. In one example, the parameters correspond to ML features. Example loss functions include a standard cross entropy loss function, a focal loss function, a dice loss function, and a self-adjusting loss function, to name a few. The model trainer 254 may iteratively train the time-delay ML model 268. In one embodiment, training the time-delay ML model 268 includes employing an optimizer that trains the time-delay ML model 268 using training data 266 until certain conditions are met, for example, as determined by the model evaluator 256. Alternatively, the model trainer 254 may feed one set of training data 266 to the time-delay ML model 268 to generate a predicted output that is used by the model evaluator 256.

Example training data 266 includes any labeled data or unlabeled data. In one embodiment, unlabeled sensor data is received, and time delays between the sensor data are identified and tagged with a label identifying the time delay. In one embodiment, other labels (for example, non-binary labels or binary labels used to train the time-delay ML model 268) such as labels for a type of field from which the sensor data is taken and geographic coordinates are added. However, the labeled data 266 is not limited to these examples. Instead, labeled data 266 may include any suitable input data that can help the model make a prediction (e.g., harvest mass flow, engine torque, and so forth) and a labeled output (e.g., a time delay). In the context of supervised ML learning, a human manually labels the output. In some embodiments, the data is automatically labeled by the ML model 268.

After the model trainer 254 finishes training the time-delay ML model 268, the time-delay ML model 268 is able to make predictions (known as inferences) on new data sets that do not have the labeled output and only have the input data. However, the accuracy of the time-delay ML model may be improved if the time-delay ML model 268 is not making predictions on data for which the time-delay ML model 268 has not been trained on and has not seen before. This is known as Generalization.

To avoid this issue, the model evaluator 256 may evaluate the accuracy of the time-delay ML model 268 trained by the model trainer 254. In some embodiments, the model evaluator 256 is configured to assess the accuracy of time-delay ML model 268 based on a loss (e.g., error) determined based on the loss function. The model evaluator 256 may validate the time-delay ML model 268. In some embodiments, the model evaluator 256 may validate the time-delay ML model 268 based on training data 266 used for validation purposes instead of training purposes. In some embodiments, the training data 266 used by the model evaluator 256 to validate the time-delay ML model 268 corresponds to training data 266 that is different from the training data 266 used by the model trainer 254 to train the time-delay ML model 268. In some embodiments, the training data 266 received via the model generating engine 250 from storage 260 may be split into training data used by the model trainer 254 and training data used by the model evaluator 256. In one embodiment, the training data 266 used by the model evaluator 256 is unlabeled, while the training data 266 used by the model trainer 254 is labeled.

The model evaluator 256 may validate the time-delay ML model 268 based on a score function. The score function may facilitate the determination of probabilistic scores for the time-delay ML model 268 or estimated averages for regression problems, to name a couple examples. It should be understood that the score function may include any suitable algorithm applied to training data 266 to uncover probabilistic insights indicative of the accuracy of the time-delay ML model 268. In some embodiments, the model evaluator 256 may employ a score function to determine whether the time-delay ML model 268 is at or above a validation threshold value indicative of an acceptable model validation metric. The model validation metric may include a percent accuracy or fit associated with applying the time-delay ML model 268 trained by the model trainer 254 to the training data 266. If the model evaluator 256 determines that the time-delay ML model 268 fails to meet the model validation metric, then the model trainer 254 may continue to train the time-delay ML model 268. On the other hand, if the model evaluator 256 determines that the time-delay ML model 268 passes validation, the model deploying engine 258 may deploy the time-delay ML model 268, for example, to the user device 120.

In some embodiments, the model deploying engine 258 may receive a time-delay ML model 268 determined to be sufficiently trained. The model deploying engine 258 may deploy a trained machine learning model to the mass flow harvest detection tool 210. As discussed herein, the mass flow harvest detection tool 210 may use the trained machine learning model deployed via the model deploying engine 258 to perform the functionality described herein.

The farming data deploying engine 270 may deploy the mass flow harvest detection tool 210, its outputs, and/or the time-delay ML model 268 generated by the model generating engine 250 to any suitable computing device (e.g., user device 120), via any suitable abstraction layer. For example, the farming data deploying engine 270 may transmit the mass flow harvest detection tool 210, its outputs, and/or the machine learning model to the operating system layer, application layer, hardware layer, and so forth, associated with a device, such as the harvester 10a (FIG. 1B), the work vehicle 12 (FIG. 1B), and the user device 120 (FIG. 1B). In one embodiment, the mass flow harvest detection tool 210, the model generating engine 250, or any of their components may integrate with an existing software application, such as a work management or productivity application. For example, the mass flow harvest detection tool 210, the model generating engine 250, or any of their components may be installed as a plug-in (for example, a plug-in extension) to a web-based application or browser or the computer productivity application. In this manner, a computing system may present a prescription map with improved accuracy due to the applied time delay.

In the context of the farming data deploying engine 270 transmitting the mass flow harvest detection tool 210, its outputs, and/or the machine learning model (e.g., the operating system layer) of a user device, analytics may be generated to provide real-time insights into the harvesting process. Instead of manually altering sensor data, the sensor data may automatically be corrected based on a time delay determined by the cross-correlation engine 220 or the ML predictor 224. Alternatively, the computing device may access the functionality described herein as any suitable software-as-a-service (SaaS) service or by any other means.

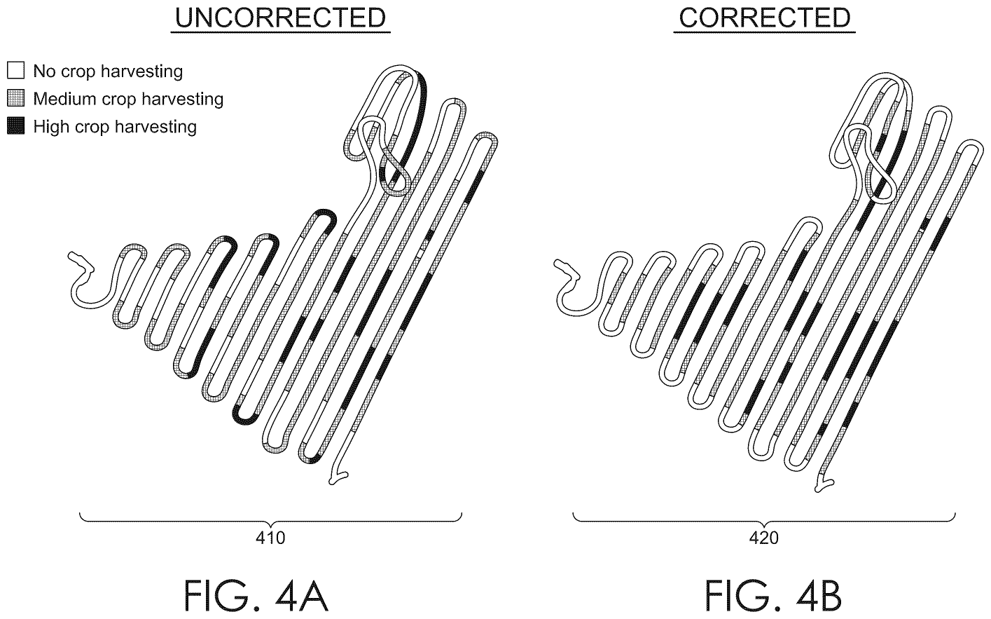

In one embodiment, the farming data deploying engine 270 may be generally responsible for presenting content and related information, such as the information displayed in FIGS. 4A and 4B. The farming data deploying engine 270 may comprise one or more applications or services on a user device, across multiple user devices, or in the cloud. For example, in one embodiment, presentation component 916 (FIG. 9) manages the presentation of content to a user across multiple user devices associated with that user. In some embodiments, presentation component 916 (FIG. 9) may determine a format in which content is to be presented. In some embodiments, presentation component 916 (FIG. 9) generates user interface elements, as described herein. Such user interface elements can include queries, prompts, graphic buttons, sliders, menus, audio prompts, alerts, alarms, vibrations, pop-up windows, notification-bar or status-bar items, in-app notifications, or other similar features for interfacing with a user.

Turning to FIG. 3, depicted is an example plurality of plots 300, 310, and 320 depicting results of implementing aspects of the architecture of FIG. 2 into aspects of the harvester system 100 of FIG. 1B or the harvester 10 of FIG. 1A, in accordance with an aspect described herein. As illustrated, the first plot 300 depicts first sensor data 302 from a first sensor, such as a mass flow sensor. In the illustrated example, the first sensor data 302 includes a first sensor signal 304 indicative of a mass flow rate (presented on a y-axis) measured over time (presented on an x-axis). Additionally, the example second plot 310 depicts second sensor data 312 from a second sensor, such as an engine torque sensor. In the illustrated example, the second sensor data 312 includes a second time-stamped signal 314 indicative of an engine torque output (presented on a y-axis) measured over time (presented on an x-axis). To facilitate comparison of the first plot 300 and the second plot 310, the time scale (on the x-axis) includes the same units and range.

In this example, the first sensor signal 304 is delayed relative to the second sensor signal, as incited by the difference in time during which the local minimums 330 occur. In the first plot 300, the local minimum 330 in the first sensor signal 304 occurs after the local minimum 330 in the second plot 310. Because in certain instances the mass flow rate generally correlates to the engine torque output, these two local minimums 330 would be expected to occur at the same time. However, due to the time delay of the first sensor signal 304, these two example signals have time differences.

Continuing with FIG. 3, the embodiments of the mass flow harvest detection tool 210 may be employed to generate the third plot 320. In the third plot 320, the cross-correlation (for example, determined by the cross-correlation engine 220 of FIG. 2) is plotted against the same time range (along the x-axis). As discussed above with respect to the cross-correlation engine 220 of FIG. 2, equation 5 may be used to calculate the time delay. In particular, after the cross-correlation engine 220 calculates the cross-correlation between the two signals, the maximum (or minimum if the signals are negatively correlated) of the cross-correlation function indicates the point in time where the signals are best aligned. The difference between the midway point 340 of the time range and time at which the maximum of the cross-correlation occurs corresponds to the time delay. In this example, applying this calculated time delay to the first sensor signal reduces or altogether eliminates the time delay and improves the generation of prescription maps.

Although examples discussed herein include two specific types of sensor data, it should be understood that the embodiments disclosed herein are applicable to additional or alternative types of sensor data in addition or alternative to those disclosed herein.

Turning to FIGS. 4A and 4B, depicted are two plots 410 and 420, illustrating levels of crop harvesting along a field. In both plots, the illustrated pattern corresponds to a travel path of a harvester 10 (FIG. 1A and 1B) throughout a field. The two plots 410 include a legend defining a region of low crop harvesting (shown as “no crop harvesting” with a white line), a region of medium crop harvesting (shown as “medium crop harvesting” with a checkered-patterned lined), and a region of high crop harvesting (shown as “high crop harvesting” with a solid dark line). The x coordinates may correspond to a lateral direction of a field and the y coordinates may correspond to a longitudinal direction of the field. In these two plots, 410 and 420, the harvester 10 travels along numerous winding paths that are defined by various turns. One would expect that as the harvester 10 executes a turn and transitions from traveling along a first substantially linear direction to traveling along a second substantially linear direction, the quantity of crops harvested would be less than the crop harvested as the harvester 10 travels along the linear direction.

However, the uncorrected plot 410 of FIG. 4A shows that the quantity of crops is lowest after achieving the turn and while the harvester 10 is traveling along a linear path. In one example, the uncorrected plot 410 includes the sensor data indicative of a mass flow rate from the harvester. Applying a time delay, as determined by the cross-correlation engine 220 or the ML predictor 224, may update the sensor data to reduce any time delays. For example, the corrected plot 420 of FIG. 4B has been updated to offset a timing of the sensor data based on a time delay. Accordingly, the corrected plot 420 of FIG. 4B shows the lowest level of crop harvesting while the harvester executes turns, and the highest level of crop harvesting while the harvester travels along the linear trajectory.

Turning now to FIGS. 5, 6, and 7, aspects of example process flows 500, 600, and 700 are illustratively depicted for some embodiments of the disclosure. Process flows 500, 600, and 700 each comprise a method (sometimes referred to herein as method 500, 600, and 700) that may be carried out to implement various example embodiments described herein. For instance, at least one of process flow 500, 600, or 700 are performed to perform embodiments described herein.

Each block or step of process flow 500, process flow 600, process flow 700, and other methods described herein comprises a computing process that may be performed using any combination of hardware, firmware, and/or software. For instance, various functions are carried out by a processor executing instructions stored in memory, such as memory 912 as described in FIG. 9 and. The methods may also be embodied as computer-usable instructions stored on computer storage media. The methods may be provided by a stand-alone application, a service or hosted service (stand-alone or in combination with another hosted service), or a plug-in to another product, to name a few. For example, the blocks of process flow 500, 600, and 700 that correspond to actions (or steps) to be performed (as opposed to information to be processed or acted on) are carried out by one or more computer applications or services, in some embodiments, which operate on one or more user devices (such as computing device 900 of FIG. 9), servers, and/or are distributed across multiple user devices, and/or servers, or by a distributed computing platform, and/or are implemented in the cloud, such as described in connection with FIG. 10. In some embodiments, the functions performed by the blocks or steps of process flows 500, 600, and 700 are carried out by components of FIGS. 1A, 1B, 2, 9, and/or 10.

With reference to FIG. 5, aspects of example process flow 500 are illustratively provided for generating a prescription map. At a block 510, method 500 includes accessing, from a first sensor of a harvester, first sensor data comprising a first time-stamped signal indicative of a first parameter associated with crop harvesting performed within a field. At block 520, method 500 includes accessing, from a second sensor of the harvester, second sensor data comprising a second time-stamped signal indicative of a second parameter associated with the crop harvesting performed within the field. At block 530, method 500 includes cross-correlating the first time-stamped signal and the second time-stamped signal. At block 540, method 500 includes, based on cross-correlation of the first time-stamped signal and the second time-stamped signal, determining a time shift between the first sensor data and the second sensor data. At block 550, method 500 includes applying the time shift to the first sensor data to automatically generate a time-invariant data set. At block 560, method 500 includes generating a prescription map indicative of a plan for managing the field based at least on the second sensor data and the time-invariant data set.

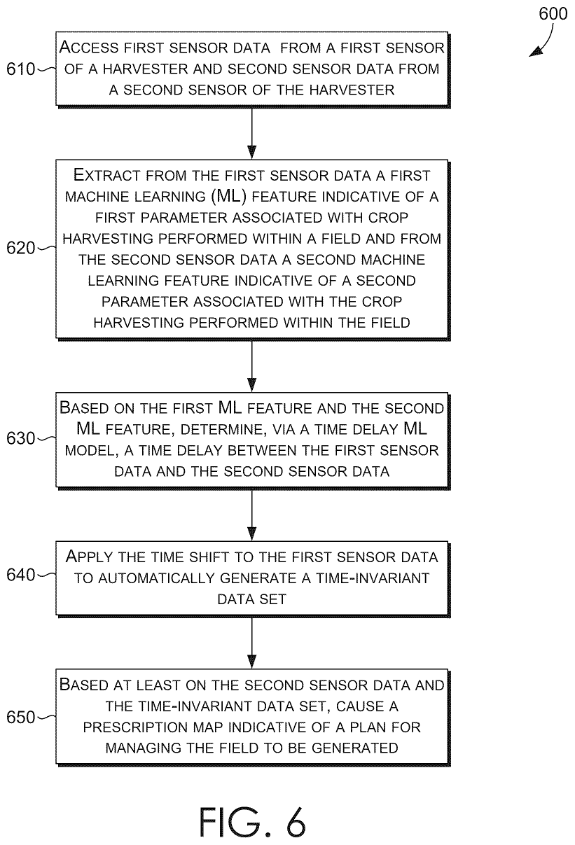

With reference to FIG. 6, aspects of example process flow 600 are illustratively provided for generating a prescription map. At block 610, method 600 includes accessing first sensor data from a first sensor of a harvester and second sensor data from a second sensor of the harvester. At block 620, method 600 includes extracting from the first sensor data a first machine learning (ML) feature indicative of a first parameter associated with crop harvesting performed within a field and from the second sensor data a second ML feature indicative of a second parameter associated with the crop harvesting performed within the field. At block 630, method 600 includes determining, via a time-delay ML model, a time delay between the first sensor data and the second sensor data based on the first ML feature and the second ML feature. At block 640, method 600 includes applying a time shift that is equal to the time delay to the first sensor data to automatically generate a time-invariant data set. At block 650, method 600 includes causing a prescription map indicative of a plan for managing the field to be generated based at least on the second sensor data and the time-invariant data set.

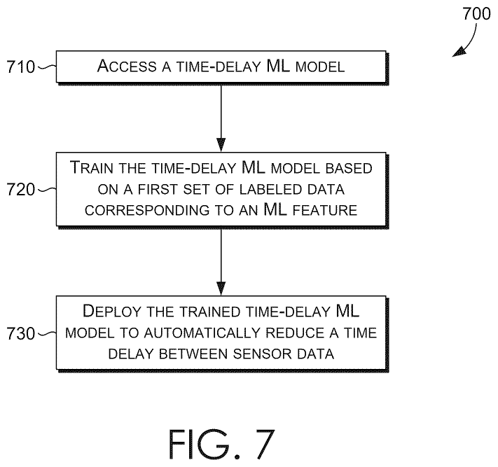

With reference to FIG. 7, aspects of example process flow 700 are illustratively provided for deploying a trained time-delay ML model. At block 710, method 700 include accessing a time-delay ML model. At block 720, method 700 includes training the time-delay ML model based on a first set of labeled data corresponding to a ML feature. At block 730, method 700 include deploying the trained time-delay ML model to automatically reduce a time delay between sensor data, as described herein.

### Example Reduction to Practice

An illustrative example embodiment of the present disclosure that has been reduced to practice is described herein. This example embodiment comprises a mass flow harvest detection tool 210 (of FIG. 2) and a model generating engine 250 (FIG. 2), as described herein, implemented to reduce or eliminate a time delay in sensor data. However, it should be noted that although this example reduction to practice focuses specifically on a specific implementation, embodiments of the technologies described herein are more generally applicable to other farming and work contexts.

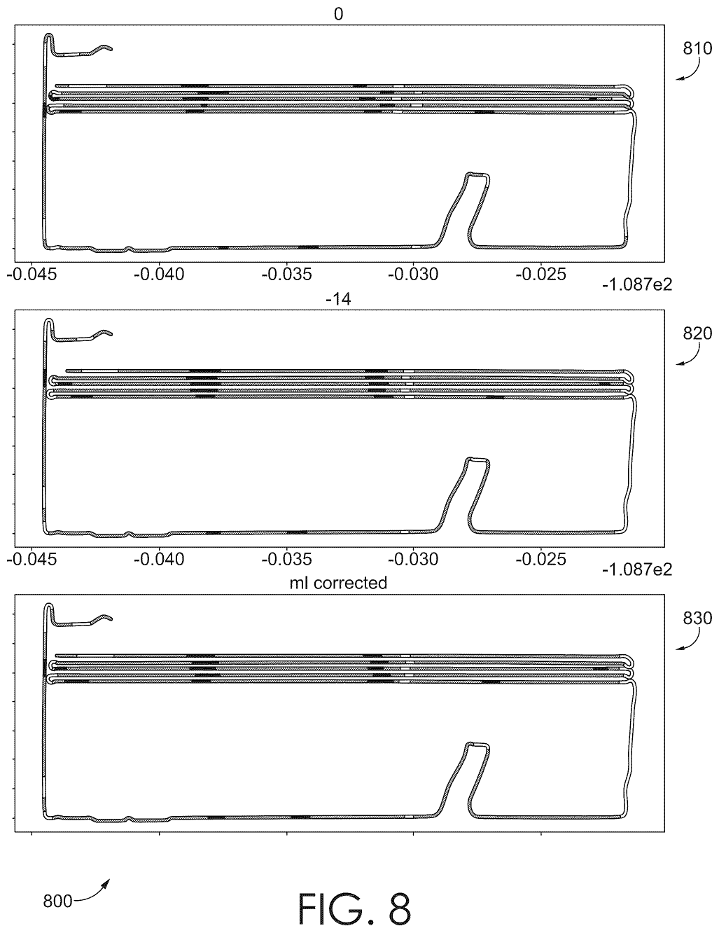

With reference to FIGS. 1-4, and with continuing reference to processes 500, 600, and 700 of FIGS. 5, 6, and 7, respectively, this example embodiment was constructed, tested, and verified as described below. In this example, machine learning models were trained to improve plots of mass flow rate across a field. For example, it was discovered that by employing 15 labeled data sets indicative of a harvester's data for a single day, a time delay in the sensor data could be reduced/removed. In particular, the 15 labeled data sets were broken up into multiple batches, each 500 seconds in duration (discussed below with respect to FIG. 8). The input data was sensor data indicative of engine torque and mass flow rate, and the output was a labeled indication regarding the time delay for the input data at various positions along the field or at various times during operation.

TABLE 1
ML Algorithm Showing Three 2D Convolutional Layers
Model: “model”

| Layer (type) | Outout Shape | Param # |
|---|---|---|
| input_1 (InputLayer) | [(None, 500, 2, 1)] | 0 |
| conv2d (Conv2D) | (None, 500, 2, 25) | 1525 |
| conv2d_1 (Conv2D) | (None, 500, 2, 50) | 75050 |
| conv2d_2 (Conv2D) | (None, 500, 2, 100) | 300100 |
| flatten (Flatten) | (None, 100000) | 0 |
| dense (Dense) | (None, 100) | 10000100 |
| dense_1 (Dense) | (None, 1) | 101 |

Total params: 10,376,876
Trainable params: 10,376,876
Non-trainable params: 0

As shown in Table 1 above, the trained time-delay ML model included three 2D convolutional layers. The input in the three 2D convolutional layers included first sensor data indicative of mass flow rate and second sensor data indicative of engine torque over 500 seconds. By only using 500 seconds, the computational expenses with training the time-delay ML model were reduced. This sensor data was collected as shown in the first plot 810. The first plot 810 shows a mass flow rate (via different depicted patterns) as the harvester traveled along a field along a path defined in the first plot 810. Indeed, the y-axis is a longitudinal direction and the x-axis is a lateral direction of a field, such that the plot shows the path traveled by the harvester. The path traveled by the harvester is the same in the first, second, and third plots 810, 820, and 830 because the underlying sensor data is the same in all three plots (except in the second plot 820 where an automatic fourteen second time delay is applied to the first sensor data indicative of a mass flow rate, and in the third plot 830, where the first sensor data indicative of a mass flow rate was input into the trained ML model). As illustrated, by employing the embodiments disclosed herein, a sensor delay in the first sensor data was decreased and the accuracy of the third plot 830 was increased as the lowest level of crop harvesting occurred while the harvester executed turns (for example, transitioning from traveling along a first substantially linear path to traveling along a second substantially linear path), and the highest level of crop harvesting occurred while the harvester traveled along the linear trajectory.

### Example Computing Environments

Having described various implementations, several example computing environments suitable for implementing embodiments of the disclosure are now described, including an example computing device and an example distributed computing environment in FIGS. 9 and 10, respectively. With reference to FIG. 9, an example computing device is provided and referred to generally as computing device 900. The computing device 900 is but one example of a suitable computing environment and is not intended to suggest any limitation as to the scope of use or functionality of embodiments of the disclosure, and nor should the computing device 900 be interpreted as having any dependency or requirement relating to any one or combination of components illustrated.

Embodiments of the disclosure are described in the general context of computer code or machine-useable instructions, including computer-useable or computer-executable instructions, such as program modules, being executed by a computer or other machine such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure may be practiced in a variety of system configurations, including mobile devices, consumer electronics, general-purpose computers, more specialty computing devices, or the like. Embodiments of the disclosure may also be practiced in distributed computing environments where tasks are performed by remote-processing devices that are linked through a communications network. In a distributed computing environment, program modules may be located in both local and remote computer storage media, including memory storage devices.

Some embodiments comprise an end-to-end software-based system that operates within system components described herein to operate computer hardware to provide system functionality. At a low level, hardware processors may execute instructions selected from a machine language (also referred to as machine code or native) instruction set for a given processor. The processor recognizes the native instructions and performs corresponding low-level functions relating to, for example, logic, control, and memory operations. Low-level software written in machine code can provide more complex functionality to higher level software. Accordingly, in some embodiments, computer-executable instructions include any software, including low-level software written in machine code, higher level software such as application software, and any combination thereof. In this regard, the system components can manage resources and provide services for system functionality. Any other variations and combinations thereof are contemplated with the embodiments of the present disclosure.

With reference to FIG. 9, computing device 900 includes a bus 910 that directly or indirectly couples to the following devices: memory 912, one or more processors 914, one or more presentation components 916, one or more input/output (I/O) ports 918, one or more I/O components 920, and an illustrative power supply 922. Bus 910 represents what may be one or more buses (such as an address bus, data bus, or combination thereof). Although the various blocks of FIG. 9 are shown with lines for the sake of clarity, in reality, these blocks represent logical, not necessarily actual, components. For example, a presentation component includes a display device, such as an I/O component. Also, processors have memory. The inventors hereof recognize that such is the nature of the art and reiterate that the diagram of FIG. 9 is merely illustrative of an example computing device that can be used in connection with one or more embodiments of the present disclosure. Distinction is not made between such categories as “workstation,” “server,” “laptop,” or “handheld device,” as all are contemplated within the scope of FIG. 9 and with reference to “computing device.”

Computing device 900 typically includes a variety of computer-readable media. Computer-readable media can be any available media that can be accessed by computing device 900 and includes both volatile and non-volatile, removable and non-removable media. By way of example, and not limitation, computer-readable media comprises computer storage media and communication media. Computer storage media includes both volatile and non-volatile, removable and non-removable media implemented in any method or technology for the storage of information such as computer-readable instructions, data structures, program modules, or other data. Computer storage media includes, but is not limited to, random-access memory (RAM), read-only memory (ROM), electrically erasable programmable read-only memory (EEPROM), flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 900. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner so as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 912 includes computer storage media in the form of volatile and/or non-volatile memory. The memory may be removable, non-removable, or a combination thereof. Hardware devices include, for example, solid-state memory, hard drives, and optical-disc drives. Computing device 900 includes one or more processors 914 that read data from various entities such as memory 912 or I/O components 920. As used herein, the term processor or “a processer” may refer to more than one computer processor. For example, the term processor (or “a processor”) may refer to at least one processor, which may be a physical or virtual processor, such as a computer processor on a virtual machine. The term processor (or “a processor”) also may refer to a plurality of processors, each of which may be physical or virtual, such as a multiprocessor system, distributed processing or distributed computing architecture, cloud computing system, or parallel processing by more than a single processor. Further, various operations described herein as being executed or performed by a processor may be performed by more than one processor.

Presentation component(s) 916 presents data indications to a user or other device. Presentation components include, for example, a display device, speaker, printing component, vibrating component, and the like.

The I/O ports 918 allow computing device 900 to be logically coupled to other devices, including I/O components 920, some of which may be built in. Illustrative components include a microphone, joystick, game pad, satellite dish, scanner, printer, or a wireless device. The I/O components 920 may provide a natural user interface (NUI) that processes air gestures, voice, or other physiological inputs generated by a user. In some instances, inputs are transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, red-green-blue (RGB) camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

Some embodiments of computing device 900 include one or more radio(s) 924 (or similar wireless communication components). The radio transmits and receives radio or wireless communications. The computing device 900 may be a wireless terminal adapted to receive communications and media over various wireless networks. Computing device 900 may communicate via wireless protocols, such as code division multiple access (“CDMA”), global system for mobiles (“GSM”), or time division multiple access (“TDMA”), as well as others, to communicate with other devices. In one embodiment, the radio communication is a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (for example, a primary connection and a secondary connection). A short-range connection includes, by way of example and not limitation, a Wi-Fi® connection to a device (for example, mobile hotspot) that provides access to a wireless communications network, such as a WLAN connection using the 802.11 protocol. A Bluetooth connection to another computing device is a second example of a short-range connection, or a near-field communication connection. A long-range connection may include a connection using, by way of example and not limitation, one or more of CDMA, general packet radio service (GPRS), GSM, TDMA, and 802.16 protocols.

Referring now to FIG. 10, an example distributed computing environment 1000 is illustratively provided, in which implementations of the present disclosure may be employed. In particular, FIG. 10 shows a high-level architecture of an example cloud computing platform 1010 that can host a technical solution environment, or a portion thereof (for example, a data trustee environment). It should be understood that this and other arrangements described herein are set forth only as examples. For example, as described above, many of the elements described herein are implemented as discrete or distributed components or in conjunction with other components, and in any suitable combination and location. Other arrangements and elements (for example, machines, interfaces, functions, orders, and groupings of functions) can be used in addition to or instead of those shown.

Data centers can support distributed computing environment 1000 that includes cloud computing platform 1010, rack 1020, and node 1030 (for example, computing devices, processing units, or blades) in rack 1020. The technical solution environment can be implemented with cloud computing platform 1010, which runs cloud services across different data centers and geographic regions. Cloud computing platform 1010 can implement fabric controller 1040 component for provisioning and managing resource allocation, as well as the deployment, upgrade, and management of cloud services. Typically, cloud computing platform 1010 acts to store data or run service applications in a distributed manner. Cloud computing platform 1010 in a data center can be configured to host and support the operation of endpoints of a particular service application. Cloud computing platform 1010 may be a public cloud, a private cloud, or a dedicated cloud.

Node 1030 can be provisioned with host 1050 (for example, operating system or runtime environment) running a defined software stack on node 1030. Node 1030 can also be configured to perform specialized functionality (for example, compute nodes or storage nodes) within cloud computing platform 1010. Node 1030 is allocated to run one or more portions of a service application of a tenant. A tenant can refer to a customer utilizing resources of cloud computing platform 1010. Service application components of cloud computing platform 1010 that support a particular tenant can be referred to as a multi-tenant infrastructure or tenancy. The terms “service application,” “application,” or “service” are used interchangeably with regards to FIG. 10, and broadly refer to any software, or portions of software, that run on top of or access storage and computing device locations within a data center.

When more than one separate service application is being supported by nodes 1030, nodes 1030 may be partitioned into virtual machines (for example, virtual machine 1052 and virtual machine 1054). Physical machines can also concurrently run separate service applications. The virtual machines or physical machines can be configured as individualized computing environments that are supported by resources 1060 (for example, hardware resources and software resources) in cloud computing platform 1010. It is contemplated that resources can be configured for specific service applications. Further, each service application may be divided into functional portions such that each functional portion is able to run on a separate virtual machine. In cloud computing platform 1010, multiple servers may be used to run service applications and perform data storage operations in a cluster. In one embodiment, the servers perform data operations independently but are exposed as a single device, referred to as a cluster. Each server in the cluster can be implemented as a node.

Client device 1080 may be linked to a service application in cloud computing platform 1010. Client device 1080 may be any type of computing device, such as user device 120 described with reference to FIG. 1, and the client device 1080 can be configured to issue commands to cloud computing platform 1010. In embodiments, client device 1080 communicates with service applications through a virtual Internet Protocol (IP) and load balancer or other means that direct communication requests to designated endpoints in cloud computing platform 1010. The components of cloud computing platform 1010 may communicate with each other over a network (not shown), which includes, without limitation, one or more local area networks (LANs) and/or wide area networks (WANs).

Some example embodiments of the technology that may be practiced from the forgoing disclosure include the following:

Embodiment 1: a computer-implemented method, comprising: accessing, from a first sensor of a harvester, first sensor data comprising a first time-stamped signal indicative of a first parameter associated with crop harvesting performed within a field; accessing, from a second sensor of the harvester, second sensor data comprising a second time-stamped signal indicative of a second parameter associated with the crop harvesting performed within the field; cross-correlating the first time-stamped signal and the second time-stamped signal; based on cross-correlation of the first time-stamped signal and the second time-stamped signal, determining a time shift between the first sensor data and the second sensor data; applying the time shift to the first sensor data to automatically generate a time-invariant data set; and based at least on the second sensor data and the time-invariant data set, generating a prescription map indicative of a plan for managing the field.

Embodiment 2: Embodiment 1, wherein the first sensor data comprises a mass flow rate associated with the harvester and the second sensor data comprises an engine torque associated with the harvester.

Embodiment 3: Embodiment 2, further comprising: accessing a plot of mass flow sensor data versus satellite positioning data indicative of the latitude and longitude of the field, based at least on the second sensor data and the time-invariant data set; updating the plot to generate an updated plot; and communicating the updated plot to a display device associated with the harvester.

Embodiment 4: Any of Embodiments 1-3, wherein cross-correlating the first time-stamped signal and the second time-stamped signal comprises performing a digital signal processing operation to measure a similarity of the first time-stamped signal and the second time-stamped signal as a function of a lag of the first time-stamped signal relative to the second time-stamped signal.

Embodiment 5: Embodiment 4, wherein the time shift comprises the lag of the first time-stamped signal relative to the second time-stamped signal.

Embodiment 6: Any of Embodiments 1-5, wherein the time shift is based on at least one of: an average over a time period or a moving average over a subset of the time period.

Embodiment 7: Any of Embodiments 1-6, wherein the first time-stamped signal and the second time-stamped signal are cross-correlated over a time period of at least 500 seconds.

Embodiment 8: Any of Embodiments 1-7, wherein the plan for managing the field comprises an input to a farming tool to control application of fertilizer, herbicide, or seeds to the field, wherein the plan is updated based on the time-invariant data set.

Embodiment 9: Any of Embodiments 1-8, wherein the method is performed as post-processing operations associated with the harvester.

Embodiment 10: a computerized system, comprising: at least one computer processor and computer memory storing computer-useable instructions that, when used by at least one computer processor, cause the at least one computer processor to perform operations. The operations comprise: accessing, from a first sensor of a harvester, first sensor data comprising a first time-stamped signal indicative of a first parameter associated with crop harvesting performed within a field; accessing, from a second sensor of the harvester, second sensor data comprising a second time-stamped signal indicative of a second parameter associated with the crop harvesting performed within the field; cross-correlating the first time-stamped signal and the second time-stamped signal; based on cross-correlating the first time-stamped signal and the second time-stamped signal, determining a time shift between the first sensor data and the second sensor data; applying the time shift to the first sensor data to automatically generate a time-invariant data set; and based at least on the second sensor data and the time-invariant data set, generating a graphical user interface (GUI) comprising a plot indicative of at least one of the second sensor data or the time-invariant data set plotted against satellite positioning system data.

Embodiment 11: Embodiment 10, wherein the GUI is generated on a display within a cabin of the harvester.

Embodiment 12: Any of Embodiments 10-11, wherein the first sensor data comprises a mass flow rate associated with the harvester and the second sensor data comprises an engine torque associated with the harvester, and wherein the operations comprise: accessing a plot of mass flow sensor data versus satellite positioning system data indicative of the latitude and longitude of the field, based at least on the second sensor data and the time-invariant data set; updating the plot to generate an updated plot; and communicating the updated plot to a display device associated with the harvester.

Embodiment 13: Any of Embodiments 10-12, wherein cross-correlating the first time-stamped signal and the second time-stamped signal comprises performing a digital signal processing operation to measure a similarity of the first time-stamped signal and the second time-stamped signal as a function of a lag of the first time-stamped signal relative to the second time-stamped signal.

Embodiment 14: Embodiment 13, wherein the time shift comprises the lag of the first time-stamped signal relative to the second time-stamped signal.

Embodiment 15: Any of Embodiments 10-14, wherein the harvester comprises a work vehicle and a harvester assembly mechanically coupled to each other, wherein the first sensor is positioned on the harvester assembly and the second sensor is positioned on a work vehicle of the harvester.

Embodiment 16: at least one computer-storage media having computer-executable instructions embodied thereon that, when executed by a computing system having a processor and memory, cause the processor to perform operations comprising: accessing first sensor data from a first sensor of a harvester and second sensor data from a second sensor of the harvester; extracting from the first sensor data a first machine learning (ML) feature indicative of a first parameter associated with crop harvesting performed within a field and from the second sensor data a second ML feature indicative of a second parameter associated with the crop harvesting performed within the field; based on the first ML feature and the second ML feature, determining, via a time-delay ML model, a time delay between the first sensor data and the second sensor data; applying a time shift that is equal to the time delay to the first sensor data to automatically generate a time-invariant data set; and based at least on the second sensor data and the time-invariant data set, causing a prescription map indicative of a plan for managing the field to be generated.

Embodiment 17: Embodiment 16, wherein the time delay is predicted based on the time-delay ML model that is trained using a plurality of labeled time delays corresponding to first sensor training data or second sensor training data.

Embodiment 18: Embodiment 17, wherein the first sensor data comprises a mass flow rate associated with the harvester, the second sensor data comprises an engine torque associated with the harvester, the first sensor training data comprises a prior mass flow rate, and the second sensor training data comprises a prior engine torque.

Embodiment 19: Any of Embodiments 16-18, wherein the first ML feature comprises an indication of a mass flow rate that is formatted to be consumable by the time-delay ML model, and the second ML feature comprises an indication of an engine torque that is formatted to be consumable by the time-delay ML model.

Embodiment 20: Any of Embodiments 16-19, wherein the prescription map defines operating parameters of the harvester at different geographic coordinates within the field.

### Additional Structural and Functional Features of Embodiments of Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

For purposes of this disclosure, the word “including” has the same broad meaning as the word “comprising,” and the word “accessing” comprises “receiving,” “referencing,” or “retrieving.” Furthermore, the word “communicating” has the same broad meaning as “receiving” or “transmitting” as facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

Unless otherwise stated, the term “coupling,” and the like, may be affixing, either directly or indirectly, two components. Coupled components may be removably secured or permanently affixed unless otherwise stated. Further, the term is not meant to imply a particular method of affixing components together.

As used herein, the term “set” may be employed to refer to an ordered (e.g., sequential) or an unordered (e.g., non-sequential) collection of objects (or elements), such as machines (for example, computer devices), physical and/or logical addresses, graph nodes, graph edges, functionalities, and the like. As used herein, a set may include N elements, where N is any positive integer. That is, a set may include 1, 2, 3 . . . N objects and/or elements, where N is a positive integer with no upper bound. Therefore, as used herein, a set does not include a null set (i.e., an empty set), that includes no elements (for example, N=0 for the null set). A set may include only a single element. In other embodiments, a set may include a number of elements that is significantly greater than one, two, three, or billions of elements. A set may be an infinite set or a finite set. The objects included in some sets may be discrete objects (for example, the set of natural numbers [symbol] ). The objects included in other sets may be continuous objects (for example, the set of real numbers [symbol] ). In some embodiments, “a set of objects” that is not a null set of objects may be interchangeably referred to as either “one or more objects” or “at least one object,” where the term “object” may stand for any object or element that may be included in a set. Accordingly, the phrases, “one or more objects” and “at least one object” may be employed interchangeably to refer to a set of objects that is not the null or empty set of objects. A set of objects that includes at least two of the objects may be referred to as “a plurality of objects.”

As used herein, the term “subset” is a set that is included in another set. A subset may be, but is not required to be, a proper or strict subset of the other set that the subset is included within. That is, if set B is a subset of set A, then in some embodiments, set B is a proper or strict subset of set A. In other embodiments, set B is a subset of set A, but not a proper or a strict subset of set A. For example, set A and set B may be equal sets, and set B may be referred to as a subset of set A. In such embodiments, set A may also be referred to as a subset of set B. Two sets may be disjointed sets if the intersection between the two sets is the null set.

As used herein, the terms “application” or “app” may be employed interchangeably to refer to any software-based program, package, or product that is executable via one or more (physical or virtual) computing machines or devices. An application may be any set of software products that, when executed, provide an end-user with one or more computational and/or data services. In some embodiments, an application may refer to a set of applications that may be executed together to provide the one or more computational and/or data services. The applications included in a set of applications may be executed serially, in parallel, or any combination thereof. The execution of multiple applications (comprising a single application) may be interleaved. For example, an application may include a first application and a second application. An execution of the application may include the serial execution of the first and second application or a parallel execution of the first and second applications. In other embodiments, the execution of the first and second application may be interleaved.

For purposes of a detailed discussion above, embodiments of the present invention are described with reference to a computing device or a distributed computing environment; however, the computing device and distributed computing environment depicted herein are non-limiting examples. Moreover, the terms “computer system” and “computing system” may be used interchangeably herein, such that a computer system is not limited to a single computing device, nor does a computing system require a plurality of computing devices. Rather, various aspects of the embodiments of this disclosure may be carried out on a single computing device or a plurality of computing devices, as described herein. Additionally, components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A computer-implemented method, comprising:
accessing, from a first sensor of a harvester, first sensor data comprising a first time-stamped signal indicative of a first parameter associated with crop harvesting performed within a field;
accessing, from a second sensor of the harvester, second sensor data comprising a second time-stamped signal indicative of a second parameter associated with the crop harvesting performed within the field;
cross-correlating the first time-stamped signal and the second time-stamped signal;
based on cross-correlating the first time-stamped signal and the second time-stamped signal, determining a time shift between the first sensor data and the second sensor data;
applying the time shift to the first sensor data to automatically generate a time-invariant data set; and
based at least on the second sensor data and the time-invariant data set, generating a prescription map indicative of a plan for managing the field.

2. The computer-implemented method of claim 1, wherein the first sensor data comprises a mass flow rate associated with the harvester, and the second sensor data comprises an engine torque associated with the harvester.

3. The computer-implemented method of claim 2, further comprising:
accessing a plot of mass flow sensor data versus satellite positioning system data indicative of a latitude and longitude of the field;
based at least on the second sensor data and the time-invariant data set, updating the plot to generate an updated plot; and
communicating the updated plot to a display device associated with the harvester.

4. The computer-implemented method of claim 1, wherein cross-correlating the first time-stamped signal and the second time-stamped signal comprises measuring a similarity of the first time-stamped signal and the second time-stamped signal as a function of a lag of the first time-stamped signal relative to the second time-stamped signal.

5. The computer-implemented method of claim 4, wherein the time shift comprises the lag of the first time-stamped signal relative to the second time-stamped signal.

6. The computer-implemented method of claim 1, wherein the time shift is based on at least one of: an average over a time period or a moving average over a subset of the time period.

7. The computer-implemented method of claim 1, wherein the first time-stamped signal and the second time-stamped signal are cross-correlated over a time period of at least 500 seconds.

8. The computer-implemented method of claim 1, wherein the plan for managing the field comprises an input to a farming tool to control application of fertilizer, herbicide, or seeds to the field, wherein the plan is updated based on the time-invariant data set.

9. The computer-implemented method of claim 1, wherein the method is performed as post-processing operations associated with the harvester.

10. A computerized system, comprising:
at least one computer processor; and
computer memory storing computer-useable instructions that, when used by at least one computer processor, cause the at least one computer processor to perform operations comprising:
accessing, from a first sensor of a harvester, first sensor data comprising a first time-stamped signal indicative of a first parameter associated with crop harvesting performed within a field;
accessing, from a second sensor of the harvester, second sensor data comprising a second time-stamped signal indicative of a second parameter associated with the crop harvesting performed within the field;
cross-correlating the first time-stamped signal and the second time-stamped signal;
based on cross-correlating the first time-stamped signal and the second time-stamped signal, determining a time shift between the first sensor data and the second sensor data;
applying the time shift to the first sensor data to automatically generate a time-invariant data set; and
based at least on the second sensor data and the time-invariant data set, generating a graphical user interface (GUI) comprising a plot indicative of at least one of the second sensor data or the time-invariant data set plotted against satellite positioning system data.

11. The computerized system of claim 10, wherein the GUI is generated on a display within a cabin of the harvester.

12. The computerized system of claim 10, wherein the first sensor data comprises a mass flow rate associated with the harvester and the second sensor data comprises an engine torque associated with the harvester, and wherein the operations comprise:
accessing a plot of mass flow sensor data over time versus satellite positioning system data indicative of a latitude and longitude of the field;
based at least on the second sensor data and the time-invariant data set, updating the plot to generate an updated plot; and
communicating the updated plot to a display device associated with the harvester.

13. The computerized system of claim 10, wherein cross-correlating the first time-stamped signal and the second time-stamped signal comprises measuring a similarity of the first time-stamped signal and the second time-stamped signal as a function of a lag of the first time-stamped signal relative to the second time-stamped signal, and wherein the time shift comprises the lag of the first time-stamped signal relative to the second time-stamped signal.

14. The computerized system of claim 10, wherein the harvester comprises a work vehicle mechanically coupled to a harvester assembly, wherein the first sensor is positioned on the harvester assembly and the second sensor is positioned on a work vehicle of the harvester.

15. At least one computer-storage media having computer-executable instructions embodied thereon that, when executed by a computing system having a processor and memory, cause the processor to perform operations comprising:
accessing first sensor data from a first sensor of a harvester and second sensor data from a second sensor of the harvester;
extracting from the first sensor data a first machine learning (ML) feature indicative of a first parameter associated with crop harvesting performed within a field and from the second sensor data a second ML feature indicative of a second parameter associated with the crop harvesting performed within the field;
based on the first ML feature and the second ML feature, determining, via a time-delay ML model, a time delay between the first sensor data and the second sensor data;
applying a time shift equal to the time delay to the first sensor data to automatically generate a time-invariant data set; and
based at least on the second sensor data and the time-invariant data set, causing a prescription map indicative of a plan for managing the field to be generated.

16. The at least one computer-storage media of claim 15, wherein the time-delay ML model comprises a plurality of layers that extract and compare features, and that output a prediction.

17. The at least one computer-storage media of claim 15, wherein the time delay is predicted based on the time-delay ML model that is trained using a plurality of labeled time delays corresponding to first sensor training data or second sensor training data.

18. The at least one computer-storage media of claim 17, wherein the first sensor data comprises a mass flow rate associated with the harvester, the second sensor data comprises an engine torque associated with the harvester, the first sensor training data comprises a prior mass flow rate, and the second sensor training data comprises a prior engine torque.

19. The at least one computer-storage media of claim 15, wherein the first ML feature comprises an indication of a mass flow rate that is consumed by the time-delay ML model, and the second ML feature comprises an indication of an engine torque that is consumed by the time-delay ML model.

20. The at least one computer-storage media of claim 15, wherein the prescription map defines operating parameters of the harvester at different geographic coordinates within the field.
